(19) United States
(12) Patent Application Publication
(10) Pub. No.: US 2026/0217958 A1
(43) Pub. Date: Jul. 30, 2026

(54) Plastic Composition, Use of The Plastic Composition, and Method for Producing a Molded Body

(71) Applicant: DIPROmat GmbH, Adelshofen (DE)

(72) Inventor: Uwe Stenglin, Adelshofen (DE)

(21) Appl. No.: 19/141,787

(22) PCT Filed: Dec. 20, 2023
(86) PCT No.: PCT/EP2023/087108

§ 371 Date: Jun. 20, 2025

(30) Foreign Application Priority Data
Dec. 23, 2022 (EP) 22216443.6

(51) Int. Cl. C08L 23/12; C08J 5/04; C08K 7/14; C08L 53/02

(52) U.S. Cl. CPC C08L 23/12; C08J 5/043; C08K 7/14; C08L 53/025; C08J 2323/12; C08J 2423/06; C08J 2453/02; C08L 2205/025; C08L 2205/03; C08L 2207/04; C08L 2207/066

(57) ABSTRACT

A plastics composition is provided, wherein the plastics composition contains at least one polyolefin and at least one thermoplastic elastomer, wherein the at least one thermoplastic elastomer is a copolymer that has at least one block A based on diene and at least one block B based on alpha-methylstyrene, wherein the ratio of the difference between the shrinkage of the polyolefin and the shrinkage of the plastics composition to the shrinkage of the polyolefin has at least a value of 30%, wherein the shrinkages are determined in accordance with DIN ISO 294-4. The present disclosure also relates to the use of the plastics composition for injection molding, extrusion or additive manufacturing, articles formed from the plastics composition, and to a method for producing a shaped article.

### CROSS-REFERENCE TO RELATED APPLICATIONS

This application is the United States national phase of International Patent Application No. PCT/EP2023/087108 filed Dec. 20, 2023, and claims priority to European Patent Application No. 22216443.6 filed Dec. 23, 2022, the disclosures of each of which are hereby incorporated by reference in their entireties.

### BACKGROUND

### Technical Field

The present disclosure relates to a plastics composition, to the use of the plastics composition, and to a method for producing a shaped article.

### Technical Considerations

Polyolefins such as polypropylene (PP) or polyethylene (PE) are among the most versatile plastics used in plastics compositions. As bulk plastics, plastics compositions consisting of polyolefins are formed into a large number of shaped articles in a range of shaping processes.

A relevant shaping process is injection molding. In the case of injection molding, a shaped article is formed from a plastics composition consisting for example of polyolefin, which is injected into a tool cavity. The molten plastics composition is held in the tool cavity for an adequate length of time in order to solidify and take on the shape of the tool cavity. The cooling phase, that is to say the time required to cool the plastics composition and remove the shaped article, is an important factor for the production time and thus for manufacturing efficiency. The properties of the plastics composition, such as the thermal expansion and compressibility, determine the extent to which the molten plastics composition undergoes dimensional changes during the cooling phase. These dimensional changes that occur during the cooling phase are referred to as shrinkage, for example processing shrinkage.

Further relevant shaping processes are extrusion processes and printing processes in additive manufacturing. Known processes here are granule printing processes, powder printing processes and filament printing processes. These processes are also referred to as 3D printing processes. In the case of powder printing processes, a powder bed consisting of particles of a plastics composition, for example consisting of a polyolefin, is provided. The plastics composition is selectively melted by introducing energy, such that particles that are in contact are bonded together. After a cooling phase, a further powder layer is applied to the existing powder bed and is likewise selectively melted. This approach is repeated until a finished shaped article is obtained. In the case of a filament printing process or granule printing process, a plastics composition in the form of a filament or granules is melted in a print head and is arranged along a specific contour, where it then solidifies. The desired shaped article is obtained by arranging a plurality of layers of the plastics composition one on top of the other.

A disadvantage of plastics compositions consisting of polyolefins is however that, in the case of most shaping processes, they exhibit considerable shrinkage after solidifying. Polypropylene homopolymer is known to exhibit shrinkage of up to 2%. The problem of shrinkage is exacerbated by the fact that polyolefins exhibit a shrinkage difference in a longitudinal direction and a transverse direction, said difference being dependent on the shaping process.

A longitudinal direction is understood to mean that spatial extent of the shaped article, preferably beginning at the gate point, which extends along an introduced anisotropy of polymer chains, for example in the amorphous regions, and/or of fibers, along the flow direction of the molten plastics composition. In other words, polymer chains and/or fibers in a shaped article are at least partially oriented in the longitudinal direction. The transverse direction is that spatial extent of the shaped article which preferably extends perpendicularly with respect to the longitudinal direction.

Owing to the shrinkage difference in the longitudinal and transverse directions, not only are shaped articles having smaller dimensions obtained, but stresses are also generated in the shaped articles and lead to distortion of the shaped article. This is attributable to a reduction of the anisotropy of the polymer chains and/or fibers, with greater shrinkage occurring in the longitudinal direction owing to the more pronounced orientation. This observation is reversed in the case of thermoplastic plastics compositions with glass fiber reinforcement. Relatively low shrinkage occurs in the direction of the glass fibers, and relatively high shrinkage occurs transversely with respect to the glass fibers.

This means that, in the case of shaping processes in which tight dimensional tolerances are important, it is necessary for the mold, for example the tool cavity, to be adapted to the specific plastics composition of the polyolefin and the specific shaping process in order that a shaped article obtained exactly has the required dimensions. The occurrence of shrinkage is a problem if a mold is provided which is adapted to a particular plastics composition and/or a particular shaping process, but the plastics composition is to be changed. Although the above problem can be somewhat compensated by lengthening the cooling phase, this comes at the expense of the quantities produced, and thus at the expense of the economy of the process.

In view of the problem set out above, there is consequently a demand to provide a plastics composition which exhibits little shrinkage even with short cooling phases. It is also desirable for this plastics composition to exhibit improved mechanical properties such as high impact strength and notched impact strength, and a high heat deflection temperature (HDT).

EP 3 212 713 B2 describes that low shrinkage of a plastics composition of polypropylene can be achieved if a predominantly amorphous propylene ethylene copolymer is added to a crystalline isotactic homopolymer. A heterophase plastics composition of polypropylene is thus obtained, and it is demonstrated that the dimensions of the specimens in a longitudinal direction exhibit shrinkage of between 0.96% and 1.05%, which is less than the shrinkage of specimens of the comparative examples. U.S. Pat. No. 7,893,171 B2 in turn describes a reduction of the difference between the shrinkage in a longitudinal direction and the shrinkage in a transverse direction through the addition of a nucleating agent such as talc. Owing to more uniform shrinkage in all spatial directions, the distortion in the end product is reduced.

EP 2 955 203 A1 discloses a thermoplastic polymer composition, shoes and outsoles. U.S. Pat. No. 8,933,174 B2 and EP 2 151 478 A1 are directed to a thermoplastic polymer composition. WO 2020/058313 A1 discloses a method for selective laser sintering using a thermoplastic polymer powder.

### SUMMARY

It is an object of the present disclosure to provide an improved plastics composition, wherein the plastics composition is used to produce a shaped article that exhibits little shrinkage. It is also an object of the present disclosure to provide a use for the improved plastics composition, and a method for producing an improved shaped article, wherein the improved shaped article comprises the improved plastics composition.

The object is achieved through the provision of a plastics composition, as described herein, wherein the plastics composition comprises at least one polyolefin and at least one thermoplastic elastomer, wherein the at least one thermoplastic elastomer is a copolymer that has at least one block A based on diene and at least one block B based on alpha-methylstyrene, wherein the ratio of the difference between the shrinkage of the polyolefin and the shrinkage of the plastics composition to the shrinkage of the polyolefin has at least a value of 30%, wherein the shrinkages are determined in accordance with DIN ISO 294-4 (“Plastics-Injection molding of test specimens of thermoplastic materials—Part 4: Determination of moulding shrinkage (ISO 294-4:2018); German version EN ISO 294-4:2019”, publication date: 2019-04), wherein the plastics composition comprises inorganic reinforcement fibers in an amount of 10 wt. % to 70 wt. % in relation to the total weight of the plastics composition, wherein the inorganic reinforcement fibers are formed as flat fibers.

The object is furthermore achieved through the provision of the use of the plastics composition as described herein for injection molding, extrusion or additive manufacturing.

The object is furthermore achieved through the provision of a method as described herein for producing a shaped article, wherein the method comprises at least the following steps:
providing a plastics composition as described herein,
forming the provided plastics composition into a shaped article.

Shrinkage is preferably understood in each case to mean the shrinkage in the longitudinal direction and/or the shrinkage in the transverse direction. Shrinkage is also preferably understood to mean the processing shrinkage. Processing shrinkage is understood to mean the ratio, in percent, of the difference between the tool dimensions and the shaped article dimensions after 16 hours of storage in a standard atmosphere (temperature: 23° C., relative atmospheric humidity: 50%) to the tool dimensions. The shaped article dimensions directly after the shaping process may be the shaped article dimensions in the liquid state, and may be determined by the tool dimensions.

In other words, the ratio of the difference between the shrinkage of the polyolefin and the shrinkage of the plastics composition to the shrinkage of the polyolefin may be calculated using the following equation (1):

$$Δ \% = \frac{PO - K}{PO} \qquad ( 1 )$$

Here, PO stands for the shrinkage of the polyolefin, and K stands for the shrinkage of the plastics composition, each stated in percent. The result is the percentage difference Δ% of the shrinkage in percent. This represents the degree to which the shrinkage of the plastics composition is improved in relation to the polyolefin.

For example, if a polyolefin exhibits shrinkage of 2% and a corresponding plastics composition according to the present disclosure exhibits shrinkage of 1.4%, the result is a percentage difference of 30%. However, if the plastics composition exhibits shrinkage of 0.1% proceeding from the aforementioned polyolefin with the shrinkage of 2%, the result is a percentage difference of 95%.

According to the present disclosure, it is also possible to provide a shaped article comprising the plastics composition as described herein, the use of the shaped article, and a method for producing the plastics composition as described herein.

By means of the present disclosure, it is made possible to provide a plastics composition, wherein the plastics composition can be used to produce shaped articles. These shaped articles exhibit high dimensional stability owing to the very low shrinkage, both in the longitudinal direction and in the transverse direction. This applies to plastics compositions without reinforcement fibers and those having reinforcement fibers. For example, for plastics compositions having reinforcement fibers, the shrinkage transversely with respect to the fibers can be reduced to a minimum. In other words, the plastics composition makes it possible to produce shaped articles that exhibit little distortion.

This offers the advantage that, in shaping processes, cycle times can be shortened by virtue of the cooling time being reduced, whereby the number of shaped articles obtained per unit of time is increased. Shaping processes can thus be made more economically efficient. Furthermore, if only a specific number of shaped articles is to be produced, the process duration is significantly shortened. Energy-intensive processes, for example keeping the plastics composition in the molten state, are therefore necessary only for a relatively short period of time, which also reduces the costs for the process.

Furthermore, the shaped articles obtained from the plastics composition exhibit not only the low shrinkage but also improved mechanical properties. As a result of the addition of the thermoplastic elastomer as described herein, the shaped articles, for example mass-produced shaped articles, exhibit very high impact strengths and very high notched impact strengths. It is thus possible to obtain robust shaped articles for demanding applications, wherein the range of possible uses of shaped articles obtained in large quantities is increased.

Furthermore, owing to the improved properties, the plastics composition can be used in a large number of processes. In the case of 3D printing processes such as extrusion deposition processes using granules, powder or filament, the molten polymer is deposited on a planar plate comprising epoxy resin, glass or metal. If a plastics composition exhibits high distortion, a low heat deflection temperature or inadequate toughness, then it detaches from the build plate during the process and printing is rendered impossible. The plastics composition according to the present disclosure however has the required combination of high heat deflection temperature, high toughness and low shrinkage, so as to allow good adhesion to the build plate and make it possible to obtain distortion-free parts.

Partially crystalline thermoplastic materials offer the advantage that they are stronger, harder and/or tougher, owing to the formation of regular structures, than amorphous thermoplastic materials. They also have a higher heat deflection temperature and/or exhibit better resistance to chemicals. They therefore exhibit advantageous resistance to mechanical loads and/or chemical exposure. By contrast, amorphous thermoplastic materials are easier to process and/or exhibit less shrinkage owing to the absence of crystallization. By means of the described plastics composition, it is now possible to combine the aforementioned advantageous properties of partially crystalline thermoplastic materials with those of amorphous thermoplastic materials.

Further advantageous refinements of the present disclosure are described herein.

In some non-limiting embodiments, the polyolefin is preferably a partially crystalline thermoplastic material. The polyolefin may be of linear or branched form.

In some non-limiting embodiments, the polyolefin may also be a homopolymer or a copolymer. For example, the polyolefin may be a copolymer selected from the group consisting of random copolymer, gradient copolymer, alternating copolymer, block copolymer, graft copolymer, and/or mixtures thereof.

In some non-limiting embodiments, the polyolefin is selected from the group consisting of polypropylene (PP), for example polypropylene homopolymer (PPH), polypropylene copolymer (PPC), or polypropylene random copolymer (PPR), polyethylene (PE), for example high density polyethylene (HDPE), low density polyethylene (LDPE), linear low density polyethylene (LLDPE), very low density polyethylene (VLDPE), or medium density polyethylene (MDPE), ethylene vinyl acetate copolymer (EVA), ethylene ethyl acrylate copolymer (EEA), ethylene butyl acrylate copolymer (EBA), copolymers, and/or mixtures thereof.

In some non-limiting embodiments, the polyolefin is selected from the group consisting of PP, for example PPH, PPC, or PPR, PE, for example HDPE, LDPE, LLDPE, VLDPE, or MDPE, copolymers, and/or mixtures thereof.

In some non-limiting embodiments, the polyolefin is selected from the group consisting of PPH, PPC or PPR, copolymers, and/or mixtures thereof. In some non-limiting embodiments, the polyolefin is preferably a PPH.

In some non-limiting embodiments, the plastics composition comprises the polyolefin in an amount selected from the range of 25 wt. % to 99 wt. %, preferably of 35 wt. % to 96 wt. %, or 40 wt. % to 75 wt. %, in relation to the total weight of the plastics composition.

In some non-limiting embodiments, the polyolefin has a value for the glass transition temperature selected from the range of −100° C. to 100° C., preferably of −80° C. to 50° C., even more preferably of −70° C. to 30° C.

The glass transition temperature is determined as a function of the temperature by means of methods known from the prior art, through the use of a dynamic mechanical analysis at a frequency of 11 Hz in the tension mode.

In some non-limiting embodiments, the glass transition temperature is determined by means of dynamic mechanical analysis in accordance with the method described in ISO 6721-11:2019-06 (“Plastics-Determination of dynamic mechanical properties—Part 11: Glass transition temperature”, publication date: 2019-06).

In some non-limiting embodiments, the plastics composition comprises the thermoplastic elastomer in an amount of up to 75 wt. %, preferably of up to 70 wt. %, more preferably of up to 60 wt. %, even more preferably of up to 50 wt. %, in relation to the total weight of the plastics composition.

The inventors have found that, above the indicated amount of thermoplastic elastomer, the resistance of the plastics composition to oils and greases can decrease.

Furthermore, the plastics composition preferably comprises the thermoplastic elastomer in an amount of at least 1 wt. %, preferably of at least 4 wt. %, more preferably of at least 10 wt. %, in relation to the total weight of the plastics composition.

Even the minimal amount of thermoplastic elastomer that is present ensures that the advantageous properties of reduced shrinkage and/or improved impact strength and/or notched impact strength of the plastics composition that are obtained by means of the thermoplastic elastomer are made possible.

The thermoplastic elastomer is preferably a block copolymer, for example with the block sequence selected from the group consisting of A-B, A-B-A, or B-A-B, or a graft copolymer. In the case of the graft copolymer, the at least one block A is grafted onto the at least one block B, or the at least one block B is grafted onto the at least one block A. In a variation according to the present disclosure, the thermoplastic elastomer is a mixture of the aforementioned copolymers.

In some non-limiting embodiments, the at least one block A is selected from the group consisting of butadiene, isoprene, and combinations thereof. In a preferred embodiment, the at least one block A is based on 1,3-butadiene.

The at least one block A is preferably at least partially hydrogenated. More preferably, the at least one block A is at least 80% hydrogenated, more preferably at least 95% hydrogenated, even more preferably 100% hydrogenated.

The at least one block A of the thermoplastic elastomer preferably has a glass transition temperature of at most 100° C., preferably of at most 50° C., more preferably of at most 30° C. It is alternatively or additionally possible that the glass transition temperature of the at least one block A of the thermoplastic elastomer has a value selected from a range of −100° C. to 100° C., preferably of −80° C. to 50° C., even more preferably of −70° C. to 30° C. The glass transition temperature is determined through the use of a dynamic mechanical analysis, as described above.

In some non-limiting embodiments, the proportion of the at least one block B in the thermoplastic elastomer is selected from a range of 15 wt. % to 45 wt. %, preferably of 20 wt. % to 40 wt. %, more preferably of 30 wt. % to 32 wt. %, in relation to the total weight of the thermoplastic elastomer. In some preferred embodiments, the proportion of the at least one block B in the thermoplastic elastomer is 31 wt. % in relation to the total weight of the thermoplastic elastomer.

In some non-limiting embodiments, the at least one block B of the thermoplastic elastomer has a glass transition temperature from a range of 120° C. to 230° C., preferably of 140° C. to 215° C., more preferably of 160° C. to 170° C. The glass transition temperature is determined through the use of a dynamic mechanical analysis, as described further herein.

For example, owing to the high glass transition temperature of the at least one block B, during the cooling of a molten plastics composition according to the present disclosure after the shaping process, a crystallization process commences very quickly, preferably immediately, and the plastics composition solidifies, whereby very low shrinkage is made possible.

In some non-limiting embodiments, the thermoplastic elastomer is a block copolymer, wherein the block A is based on 1,3-butadiene, wherein at least one block A is at least 80% hydrogenated, more preferably at least 95% hydrogenated, even more preferably 100% hydrogenated, and wherein the at least one block B is selected from a range of 15 wt. % to 45 wt. %, preferably of 20 wt. % to 40 wt. %, more preferably of 30 wt. % to 32 wt. %, even more preferably of 31 wt. %, in relation to the total weight of the thermoplastic elastomer, and wherein the thermoplastic elastomer has a glass transition temperature from a range of 120° C. to 230° C., preferably of 140° C. to 215° C., more preferably of 160° C. to 170° C.

In some non-limiting embodiments, the thermoplastic elastomer has a value for a melt flow index at 230° C. and under a load of 2.16 kg selected from a range of 3 g/10 min to 7 g/10 min, preferably of 5 g/10 min to 6 g/10 min, for example in accordance with the method described in DIN EN ISO 1133-1:2012-03 (“Plastics-Determination of the melt mass-flow rate (MFR) and melt volume-flow rate (MVR) of thermoplastics—Part 1: Standard method (ISO 1133-1:2011); German version EN ISO 1133-1:2011”, publication date: 2012-03).

An advantage of the aforementioned range of the melt flow index of the thermoplastic elastomer is that it corresponds to the order of magnitude of the melt flow index that is relevant for the plastics composition according to the present disclosure. The addition of the thermoplastic elastomer therefore does not adversely affect the processability of the plastics composition in the molten state.

In some non-limiting embodiments, the ratio of the difference between the shrinkage of the polyolefin in the longitudinal direction and the shrinkage of the plastics composition in the longitudinal direction to the shrinkage of the polyolefin in the longitudinal direction has at least a value of 30%, at least of 40%, at least of 50%, wherein the shrinkages are determined in accordance with DIN ISO 294-4.

More preferably, the ratio of the difference between the shrinkage of the polyolefin in the longitudinal direction and the shrinkage of the plastics composition in the longitudinal direction to the shrinkage of the polyolefin in the longitudinal direction has a value selected from a range of 30% to 100%, more preferably of 35% to 98%, even more preferably of 40% to 90%, furthermore even more preferably of 50% to 80%, wherein the shrinkages are determined in accordance with DIN ISO 294-4.

The percentage values discussed in the two preceding paragraphs correspond to the percentage difference in the longitudinal direction Δ%_{L} and can be determined by means of the following equation (2):

$$Δ {\%}_{L} = \frac{{PO}_{L} - {K}_{L}}{{PO}_{L}} \qquad ( 2 )$$

POL corresponds to the value of the shrinkage of the polyolefin in the longitudinal direction, and K_{L} corresponds to the value of the shrinkage of the plastics composition in the longitudinal direction, each stated in percent.

In a further preferred embodiment, the ratio of the difference between the shrinkage of the polyolefin in the transverse direction and the shrinkage of the plastics composition to the shrinkage of the polyolefin in the transverse direction has at least a value of 30%, at least of 40%, at least of 50%, wherein the shrinkages are determined in accordance with DIN ISO 294-4.

More preferably, the ratio of the difference between the shrinkage of the polyolefin in the transverse direction and the shrinkage of the plastics composition in the longitudinal direction to the shrinkage of the polyolefin in the transverse direction has a value selected from a range of 30% to 100%, more preferably of 35% to 98%, even more preferably of 40% to 90%, furthermore even more preferably of 50% to 80%, wherein the shrinkages are determined in accordance with DIN ISO 294-4.

The percentage values discussed in the two preceding paragraphs correspond to the percentage difference in the transverse direction 4% Q and can be determined by means of the following equation (2):

$$Δ {\%}_{Q} = \frac{{PO}_{Q} - {K}_{Q}}{{PO}_{Q}} \qquad ( 3 )$$

PO_{Q} corresponds to the value of the shrinkage of the polyolefin in the longitudinal direction, and K_{Q} corresponds to the value of the shrinkage of the plastics composition in the longitudinal direction, each stated in percent.

Typically, unfilled partially crystalline thermoplastic materials have values for the shrinkages in the longitudinal direction and/or transverse direction in accordance with DIN EN ISO 294-4 of 1% to 2.5%, preferably 1% to 2%, wherein the shrinkages are more pronounced in the longitudinal direction.

In a further preferred embodiment, the plastics composition has a value for the shrinkage in the longitudinal direction in accordance with the method described in DIN EN ISO 294-4 selected from a range of 0% to 0.7%, preferably of 0.1% to 0.5%, preferably of 0.2% to 0.3%. Additionally or alternatively, the plastics composition has a value for the shrinkage in the transverse direction in accordance with the method described in DIN EN ISO 294-4 selected from a range of 0% to 0.7%, preferably of 0.1% to 0.5%, preferably of 0.2% to 0.3%.

Owing to the low shrinkage, for example the low shrinkage in the longitudinal direction and in the transverse direction, it is possible to provide shaped articles that exhibit very little distortion.

It is thus possible for the plastics composition in the form of a plate-like injection-molded article, having the dimensions of width: 150 mm, length: 100 mm and height: 2 mm, to have a distortion value selected from a range of 0 mm to 10 mm, preferably of 0.01 mm to 7 mm, more preferably of 0.1 mm to 3.5 mm.

To determine the distortion, the plate-like injection molded article is placed on a planar underlying surface, and each corner of the injection molded article in succession is pushed onto the underlying surface such that said corner is brought into contact with the underlying surface. The maximum possible spacing of the respectively diagonally opposite corner of the plate-like injection molded article perpendicularly with respect to the plane spanned by the underlying surface is measured.

The low distortion of the plastics composition makes it possible to provide shaped articles that exhibit high dimensional stability. In combination with the good chemical resistance of partially crystalline thermoplastic materials, it is for example possible to provide precisely fitting pipes and lines for solid, liquid and/or gaseous media, without the risk of said pipes and lines being corroded by the media or of the media escaping at the connection points.

In some non-limiting embodiments, the plastics composition has a value for the Charpy notched impact strength in accordance with the method described in DIN EN ISO 179-1:2010-11 (“Plastics-Determination of Charpy impact properties—Part 1: Non-instrumented impact test (ISO 179-1:2010); German version EN ISO 179-1:2010”, publication date: 2010-11) of at least 16 kJ/m², preferably selected from the range of 16 kJ/m² to 100 kJ/m², more preferably of 25 kJ/m² to 80 kJ/m², even more preferably of 30 kJ/m² to 65 kJ/m².

In a further preferred embodiment, the plastics composition has a value for the Charpy impact strength in accordance with the method described in DIN EN ISO 179-1:2010-11 of at least 16 kJ/m², preferably selected from the range of 16 kJ/m² to 100 kJ/m², more preferably of 30 kJ/m² to 85 kJ/m², even more preferably of 40 kJ/m² to 65 kJ/m².

In some non-limiting embodiments, the plastics composition has a value for the Izod notched impact strength in accordance with the method described in DIN EN ISO 180:2020-03 (“Plastics-Determination of Izod impact strength (ISO 180:2019); German version EN ISO 180:2019”, publication date: 2020-03) of at least 16 kJ/m², preferably selected from the range of 16 kJ/m² to 100 kJ/m², more preferably of 30 kJ/m² to 85 kJ/m², even more preferably of 40 kJ/m² to 65 kJ/m².

The aforementioned ranges of notched impact strengths and/or impact strengths ensure that the plastics composition according to the present disclosure exhibits excellent load-bearing capacities for mechanical loads. These load-bearing capacities are achieved through the addition of the thermoplastic elastomer.

Test specimens which, even after the impact test, do not break into two parts, are bent, and/or elastically spring back after the impact despite the notch, are denoted for example by the designation “NB” (non-broken). In some non-limiting embodiments, test specimens that do not break at a load of less than 80 kJ/m² during the determination of the notched impact strengths and impact strengths are denoted by the designation “NB”.

In some non-limiting embodiments, the plastics composition has a value for the heat deflection temperature (HDT) according to method B in accordance with DIN EN ISO 75-1:2020-06 (“Plastics-Determination of temperature of deflection under load—Part 1: General test method (ISO 75-1:2020); German version EN ISO 75-1:2020”, publication date: 2020-06) and DIN EN ISO 75-2:2013-08 (“Plastics-Determination of temperature of deflection under load—Part 2: Plastics and ebonite (ISO 75-2:2013); German version EN ISO 75-2:2013”, publication date: 2013-08) of at least 60° C., preferably selected from the range of 60° C. to 200° C., more preferably of 80° C. to 180° C., even more preferably of 130° C. to 165° C. The heat deflection temperature determined according to method B will hereinafter be abbreviated to HDT-B.

In method B, a force per unit area of 0.45 N/mm² is applied to the test specimen by means of weights and/or springs.

It is advantageous that, even with a proportion of for example 15 wt. % to 20 wt. % of thermoplastic elastomer, the plastics composition has a high heat deflection temperature, for example in addition to the high toughness. This is surprising, because the addition of a conventional elastomer would be expected to result in a reduction of the heat deflection temperature. The high heat deflection temperature, for example in combination with the low distortion, achieves the advantageous effect that the plastics composition is very highly suited to 3D printing processes, for example, because no detachment from a build plate occurs during the process.

The plastics composition furthermore has inorganic reinforcement fibers in an amount of 10 wt. % to 70 wt. %, preferably of 12.5 wt. % to 60 wt. %, more preferably of 15 wt. % to 50 wt. %, more preferably of 17.5 wt. % to 45 wt. %, in relation to the total weight of the plastics composition, wherein the inorganic reinforcement fibers are formed as flat fibers.

Preferably, at least 10 wt. %, more preferably at least 12.5 wt. %, more preferably at least 15 wt. %, more preferably at least 17.5 wt. %, of the inorganic reinforcement fibers in relation to the total weight of the plastics composition are formed as flat fibers.

Preferably, the inorganic reinforcement fibers also comprise round fibers in a proportion of up to 60 wt. %, more preferably up to 50 wt. %, in relation to the total weight of the plastics composition, wherein the total amount of inorganic reinforcement fibers formed as flat fibers and inorganic reinforcement fibers formed as round fibers does not exceed 70 wt. % in relation to the total weight of the plastics composition.

Preferably, the inorganic reinforcement fibers used have a mixture of flat fibers in a proportion of 10 wt. % to 60 wt. %, preferably of 15 wt. % to 50 wt. %, more preferably of 20 wt. % to 40 wt. %, more preferably of 25 wt. % to 35 wt. %, in relation to the total weight of the plastics composition, and round fibers in a proportion of 10 wt. % to 60 wt. %, preferably of 15 wt. % to 50 wt. %, more preferably of 20 wt. % to 40 wt. %, more preferably of 25 wt. % to 35 wt. %, in relation to the total weight of the plastics composition, wherein the total amount of inorganic reinforcement fibers formed as flat fibers and inorganic reinforcement fibers formed as round fibers does not exceed 70 wt. % in relation to the total weight of the plastics composition.

In a further preferred embodiment, the inorganic reinforcement fibers used have a mixture of flat fibers in a proportion of 10 wt. % to 25 wt. %, preferably of 12.5 wt. % to 20 wt. %, more preferably of 15 wt. % to 17.5 wt. %, in relation to the total weight of the plastics composition, and round fibers in a proportion of 10 wt. % to 45 wt. %, preferably of 15 wt. % to 40 wt. %, more preferably of 20 wt. % to 35 wt. %, more preferably of 25 wt. % to 35 wt. %, in relation to the total weight of the plastics composition.

Inorganic reinforcement fibers are preferably understood to mean carbon fibers, ceramic fibers, basalt fibers, glass fibers, carbon nanotubes, metallic reinforcement fibers, for example steel fibers, and mixtures thereof, preferably carbon fibers, ceramic fibers, basalt fibers, glass fibers and mixtures thereof, more preferably ceramic fibers, basalt fibers, glass fibers and mixtures thereof, more preferably basalt fibers, glass fibers and mixtures thereof, more preferably glass fibers.

Suitable ceramic fibers are for example ceramic fibers from the 3M Corporation (Saint Paul, MN, USA), which are commercially available under the trade name Nextel®. Suitable ceramic fibers are preferably selected from the group consisting of aluminoborosilicate fibers, aluminosilicate fibers, aluminum oxide fibers, and mixtures thereof.

By adding inorganic reinforcement fibers, it is possible to further reduce, or substantially entirely avoid, the shrinkage of the plastics composition.

By means of the above-described amount of reinforcement fibers, it can be ensured that the shrinkage of the plastics composition is reduced by the reinforcement fibers, preferably glass fibers, without the processability of the plastics composition being significantly impaired.

In some non-limiting embodiments, the reinforcement fibers are or comprise glass fibers. The glass fibers may be formed as flat fibers or as a mixture of flat fibers and round fibers. The glass fibers are preferably formed as flat fibers.

Suitable inorganic reinforcement fibers may preferably be coated or non-coated, wherein a coating of the inorganic reinforcement fibers may be provided over the entire surface of the fibers or over only at least one subregion of the surface.

The flat fibers preferably have a form factor of thickness to width selected from a range of 1:1.5 to 1:5, preferably of 1:2 to 1:4, more preferably of 1:2.5 to 1:3.5.

In the context of the present disclosure, the term “thickness” is preferably understood to mean the average fiber cross section that can be determined for example using an optical microscope or scanning electron microscope, in accordance with methods known to a person skilled in the art, at an adequate number of fiber cross sections, preferably at least 50 cross sections. The arithmetic mean value of these measurements furthermore preferably yields the average fiber thickness, which is preferably used to calculate the form factor.

Here, the cross section of a reinforcement fiber is preferably understood to mean an area perpendicular to the length of the fiber. A suitable cross-sectional area for determining the thickness of a fiber is situated for example at an end of a fiber or may be generated for example using a microtome in accordance with methods known to a person skilled in the art.

Analogously, the width of a fiber that is used may be determined for example using an optical microscope or scanning electron microscope, in accordance with methods known to a person skilled in the art, on an adequate number of fibers, preferably at least 50 fibers. The arithmetic mean value of these measurements furthermore preferably yields the average fiber width, which is preferably used to calculate the form factor.

The flat fibers furthermore preferably have a form factor of average fiber cross section to average fiber width, preferably determined on at least 50 fibers, from a range of 1:1.5 to 1:5, preferably of 1:2 to 1:4, more preferably of 1:2.5 to 1:3.5.

The glass fibers are preferably flat fibers, which furthermore preferably have a form factor of thickness to width from a range of 1:1.5 to 1:5.

Round fibers preferably have a diameter selected from the range from 2 μm to 15 μm, preferably 5 μm to 12 μm, and/or have a length selected from the range of 15 μm to 50 μm, preferably of 20 μm to 30 μm.

Here, round fibers preferably have a fiber cross section with a substantially round shape. Round fibers preferably have a form factor of thickness to width selected from a range of 1:1 to 1:1.4, preferably of 1:1 to 1:1.3, more preferably of 1:1 to 1:1.15.

The use of glass fibers offers the advantage that the shrinkage can be inexpensively further reduced. For example, the use of flat fibers offers the advantage that, in this way, not only is the shrinkage reduced overall, but the orientation of the fibers is also reduced owing to the above-described form factor. The flat fibers therefore preferably have a random distribution in terms of their orientation. This additionally reduces the difference between the shrinkages in the longitudinal direction and in the transverse direction.

The plastics composition may furthermore have synthetic polymer fibers, for example polyester fibers, polyamide (PA) fibers, polyethylene (PE) fibers, polymethyl methacrylate (PMMA) fibers, polylactide (PLA) fibers, poly(p-phenylene-2,6-benzobisoxazole) (PPBO) fibers, natural fibers, for example flax fibers, hemp fibers, wood fibers or sisal fibers, and/or mixtures thereof.

Preferred embodiments of polyester fibers are fibers consisting of polyethylene terephthalate (PET), and preferred embodiments of polyamide fibers are fibers consisting of poly[imino (1,6-dioxohexamethylene) iminohexamethylene] (Nylon, PA 6.6), polycaprolactam (Perlon, PA 6) and/or aromatic polyamides, preferably poly(p-phenylene terephthalamide) and/or poly(m-phenylene terephthalamide). In some non-limiting embodiments, the synthetic polymer fibers are round fibers and/or flat fibers.

In some non-limiting embodiments, the plastics composition has no mineral fillers, wherein glass is not a mineral filler within the meaning of the present disclosure.

Fillers are understood to mean materials which are present in a proportion by weight of more than 5 wt. % in relation to the total weight of the plastics composition and which are present in undissolved form in the plastics composition.

Mineral fillers are understood for example to mean silicates, sulfates, carbonates or mixtures thereof. The plastics composition preferably does not have any phyllosilicate such as talc, any chalk, any rock flour or any mixtures thereof.

In some non-limiting embodiments, the plastics composition has no filler, for example mineral filler, having a form factor of thickness to width of less than 1:1.5, preferably less than 1:1.3.

Mineral fillers are common means for minimizing the shrinkage of plastics compositions, because they reduce the differences between the shrinkage in the longitudinal direction and that in the transverse direction. However, mineral fillers reduce the overall shrinkage to a lesser extent than reinforcement fibers, for example. Mineral fillers must therefore be used in high proportions in relation to the total weight of the plastics composition in order to achieve an effect, wherein the shrinkage normally cannot be reduced below 0.7% to 1.5% in the longitudinal direction and/or transverse direction even with high proportions of mineral fillers. The slight improvement in shrinkage however leads to a range of adverse properties. For example, mineral fillers are normally of higher density than polymers, such that the end products have a higher weight. Furthermore, mineral fillers exhibit poor toughness and notched impact strength, and reduce the scratch resistance of the plastics composition.

In some non-limiting alternative embodiments, the plastics composition also comprises at least one filler, preferably mineral particulate solid, which is furthermore preferably selected from talc, metal carbonate, preferably calcium carbonate, and mixtures thereof, preferably in a proportion of at most 45 wt. %, preferably of more than 5 wt. % to at most 40 wt. %, preferably of 6.5 wt. % to 35 wt. %, more preferably of 7.5 wt. % to 25 wt. %, more preferably of 10 wt. % to 25 wt. %, in relation to the total weight of the plastics composition.

The inventors have found that the shrinkage of the plastics composition can likewise be significantly reduced by using preferably talc and/or metal carbonate, preferably calcium carbonate, more preferably chalk, in the aforementioned preferred proportion.

More preferably, the plastics composition has a mixture of reinforcement fibers, preferably glass fibers, wherein the glass fibers may preferably be formed as flat fibers or as a mixture of round fibers and flat fibers, and at least one mineral particulate solid, which is preferably selected from talc, metal carbonate, preferably calcium carbonate, more preferably chalk, and mixtures thereof, wherein the proportion of the reinforcement fibers, preferably glass fibers, ranges from 10 wt. % to 70 wt. %, preferably 12.5 wt. % 60 wt. %, more preferably 15 wt. % to 50 wt. %, more preferably 17.5 wt. % to 45 wt. %, in relation to the total weight of the plastics composition, and the proportion of the mineral particulate solid, which is preferably selected from talc, metal carbonate, preferably calcium carbonate, more preferably chalk, and mixtures thereof, is preferably at most 45 wt. %, preferably from more than 5 wt. % to at most 40 wt. %, preferably from 6.5 wt. % to 35 wt. %, more preferably from 7.5 wt. % to 25 wt. %, more preferably from 10 wt. % to 25 wt. %, in relation to the total weight of the plastics composition.

The at least one filler used in the plastics composition is preferably a mineral particulate solid, which furthermore preferably has particles with a volume-based mean particle size D50 of less than 105 μm, preferably from a range of 0.1 μm to 75.0 μm, more preferably from a range of 0.5 μm to 55.0 μm, more preferably from a range of 1.2 μm to 35.0 μm, more preferably from a range of 1.5 μm to 15.0 μm, preferably determined in accordance with the method described in DIN EN ISO 787-7:2010-02 (“General methods of test for pigments and extenders—Part 7: Determination of residue on sieve-Water method-Manual procedure (ISO 787-7:2009); German version EN ISO 787-7:2009”).

In some non-limiting embodiments, the mineral particulate solid that is used is selected from talc, metal carbonate, preferably calcium carbonate, more preferably chalk, and mixtures of talc and metal carbonate, preferably calcium carbonate, more preferably chalk, in any ratio.

Talc is a magnesium silicate hydrate, which is preferably present in powder form, and furthermore preferably has particles with a volume-based mean particle size D50 of less than 105 μm, preferably from a range of 0.1 μm to 75.0 μm, more preferably from a range of 0.5 μm to 55.0 μm, more preferably from a range of 0.9 μm to 35.0 μm, more preferably from a range of 1.2 μm to 15.0 μm, more preferably from a range of 1.5 μm to 7.0 μm, preferably determined in accordance with the method described in DIN EN ISO 787-7:2010-02 (“General methods of test for pigments and extenders—Part 7: Determination of residue on sieve-Water method-Manual procedure (ISO 787-7:2009); German version EN ISO 787-7:2009”). The talc that is used preferably comprises no fibers.

It is furthermore preferably possible for the mineral particulate solid that is used to comprise metal carbonate or consist of metal carbonate, wherein the metal is preferably selected from the group consisting of magnesium, calcium, strontium, barium, manganese, iron, cobalt, nickel, copper, zinc, silver, cadmium, bismuth, lead, and mixtures thereof, preferably magnesium, calcium, and mixtures thereof, more preferably calcium. Carbonates having the aforementioned metals may also comprise other metals, for example in the form of impurities.

A suitable metal carbonate is more preferably calcium carbonate, more preferably chalk.

The calcium carbonate that is used may comprise or consist of naturally occurring calcium carbonate, which preferably has a calcium carbonate proportion of 50 to 100 wt. % in relation to the total weight of the particles of the mineral particulate solid.

Naturally occurring calcium carbonate is preferably selected from the group consisting of calcite, coral limestone, shell limestone, dolomite, limestone, calcspar, aragonite, marble, travertine, chalk, and mixtures thereof.

Alternatively, the calcium carbonate that is used may comprise or consist of precipitated calcium carbonate, preferably with a calcium carbonate proportion of 50% to 100 wt. %, preferably 70% to 100 wt. %, in relation to the total weight of the particles of the mineral particulate solid.

Both precipitated and naturally occurring calcium carbonate may be present in amorphous form and/or consist of the crystalline modifications calcite, aragonite or vaterite and/or mixtures thereof. The crystalline modifications are preferably present, after a grinding process, in the form of individual crystals and/or the fragments thereof. Naturally occurring calcium carbonate may also include fossil residues of maritime organisms.

The calcium carbonate that is used furthermore preferably has particles with a volume-based mean particle size D50 of less than 105 μm, preferably from a range of 0.1 μm to 75.0 μm, more preferably from a range of 0.5 μm to 55.0 μm, more preferably from a range of 0.7 μm to 35.0 μm, more preferably from a range of 1.2 μm to 15.0 μm, more preferably of 1.5 μm to 7.0 μm, preferably determined in accordance with the method described in DIN EN ISO 787-7:2010-02 (“General methods of test for pigments and extenders—Part 7: Determination of residue on sieve-Water method-Manual procedure (ISO 787-7:2009); German version EN ISO 787-7:2009”).

The chalk that is used furthermore preferably has a volume-based mean particle size D50 from a range of 1.5 μm to 7.0 μm, and the talc that is used furthermore preferably has a volume-based mean particle size D50 from a range of 1.2 μm to 15.0 μm, preferably determined in each case in accordance with the method described in DIN EN ISO 787-7:2010-02 (“General methods of test for pigments and extenders—Part 7: Determination of residue on sieve—Water method—Manual procedure (ISO 787-7:2009); German version EN ISO 787-7:2009”).

It is also possible for the plastics composition to comprise at least one additive selected individually or in combination from the group consisting of stabilizers, light stabilizers, fireproofing agents, hydrophobing agents, softening agents, antioxidants, colorants, pigments, antistatic agents, silicone oils, mold release agents and/or parting agents.

Additives are understood to mean materials which are present in a proportion by weight of less than 5 wt. % in relation to the total weight of the plastics composition. Additives may be present in dissolved or undissolved form in the plastics composition.

The plastics composition preferably has the at least one additive in a proportion selected from the range of up to 5 wt. %, preferably of up to 3 wt. %, more preferably of up to 2 wt. %, in relation to the total weight of the plastics composition.

By adding additives, desired properties of the plastics composition can be obtained without adversely affecting the mechanical properties of the plastics composition.

In some non-limiting embodiments, the plastics composition has the following composition, wherein the constituents of the plastics composition are selected so as to make up 100 wt. % in sum total:

$$\begin{matrix}Polyolefin : & 25 wt . \% to 99 wt . \% , \\ Thermoplastic elastomer : & 1 wt . \% to 75 wt . \% , \\ Reinforcement fibers : & 10 wt . \% to 70 wt . \% , \\ Additives : & 0 w t . \% to 5 wt . \% ,\end{matrix}$$

$$\begin{matrix}more preferably : & \\ Polyolefin : & 30 wt . \% to 96 wt . \% , \\ Thermoplastic elastomer : & 4 wt . \% to 70 wt . \% , \\ Reinforcement fibers : & 10 wt . \% to 50 wt . \% , \\ Additives : & 0 wt . \% to 3 wt . \% ,\end{matrix}$$

$$\begin{matrix}even more preferably : & \\ Polyolefin : & 40 wt . \% to 75 wt . \% , \\ Thermoplastic elastomer : & 10 wt . \% to 60 wt . \% , \\ Reinforcement fibers : & 15 wt . \% to 40 wt . \% , \\ Additives : & 0 wt . \% to 2 wt . \% ,\end{matrix}$$

wherein the reinforcement fibers, more preferably glass fibers, are formed in each case as flat fibers or as a mixture of flat fibers and round fibers.

In some alternative embodiments, the plastics composition has the following composition, wherein the constituents of the plastics composition are selected so as to make up 100 wt. % in sum total:

$$\begin{matrix}Polyolefin : & 25 wt . \% to 99 wt . \% , \\ Thermoplastic elastomer : & 1 wt . \% to 75 wt . \% , \\ Reinforcement fibers : & 10 wt . \% to 70 wt . \% , \\ Mineral particulate solid : & 5 wt . \% to 40 wt . \% , \\ Additives : & 0 wt . \% to 5 wt . \% ,\end{matrix}$$

$$\begin{matrix}more preferably : & \\ Polyolefin : & 30 wt . \% to 96 wt . \% , \\ Thermoplastic elastomer : & 4 wt . \% to 70 wt . \% , \\ Reinforcement fibers : & 12.5 wt . \% to 50 wt . \% , \\ Mineral particulate solid : & 6.5 wt . \% to 32 wt . \% , \\ Additives : & 0 wt . \% to 3 wt . \% ,\end{matrix}$$

$$\begin{matrix}more preferably : & \\ Polyolefin : & 35 wt . \% to 82 wt . \% , \\ Thermoplastic elastomer : & 7.5 wt . \% to 65 wt . \% , \\ Reinforcement fibers : & 13.5 wt . \% to 35 wt . \% , \\ Mineral particulate solid : & 10 wt . \% to 25 wt . \% , \\ Additives : & 0 wt . \% to 2.5 wt . \% ,\end{matrix}$$

$$\begin{matrix}even more preferably : & \\ Polyolefin : & 40 wt . \% to 75 wt . \% , \\ Thermoplastic elastomer : & 10 wt . \% to 60 wt . \% , \\ Reinforcement fibers : & 15 wt . \% to 35 wt . \% , \\ Mineral particulate solid : & 15 wt . \% to 25 wt . \% , \\ Additives : & 0 wt . \% to 2 wt . \% ,\end{matrix}$$

wherein the reinforcement fibers, more preferably glass fibers, are formed in each case as flat fibers or as a mixture of flat fibers and round fibers, and wherein the mineral particulate solid is preferably selected from the group consisting of talc, chalk, and a mixture thereof.

In some non-limiting embodiments of the above-described composition, the polyolefin is a PP, preferably PPH. In a further preferred embodiment, the polyolefin is a PE, preferably an HDPE, LDPE, LLDPE, VLDPE or MDPE.

In some non-limiting embodiments of the above-described composition, the thermoplastic elastomer is a block copolymer, wherein the block A is based on 1,3-butadiene, wherein at least one block A is at least 80% hydrogenated, more preferably at least 95% hydrogenated, even more preferably 100% hydrogenated, and wherein the at least one block B is selected from a range of 15 wt. % to 45 wt. %, preferably of 20 wt. % to 40 wt. %, more preferably of 30 wt. % to 32 wt. %, even more preferably of 31 wt. %, in relation to the total weight of the thermoplastic elastomer, and wherein the thermoplastic elastomer has a glass transition temperature from a range of 120° C. to 230° C., preferably of 140° C. to 215° C., more preferably of 160° C. to 170° C.

In some non-limiting embodiments of the above-described composition, the reinforcement fibers are flat glass fibers, for example having a form factor of thickness to width selected from a range of 1:1.5 to 1:5, preferably of 1:2 to 1:4, more preferably of 1:2.5 to 1:3.5.

In a preferred embodiment, the plastics composition comprises the thermoplastic elastomer in an amount selected from the range of 1 wt. % to 75 wt. %, preferably of 4 wt. % to 70 wt. %, more preferably of 10 wt. % to 60 wt. %, comprises the polyolefin in an amount selected from the range of 25 wt. % to 99 wt. %, preferably of 35 wt. % to 96 wt. %, of 40 wt. % to 75 wt. %, and comprises flat glass fibers in an amount selected from the range of 1 wt. % to 70 wt. %, preferably of 10 wt. % to 50 wt. %, in each case in relation to the total weight of the plastics composition, wherein the proportions of the composition are selected so as to make up 100 wt. % of the plastics composition in sum total, wherein the thermoplastic elastomer is a block copolymer, wherein the at least one block A is based on 1,3-butadiene, wherein the at least one block A is at least 80% hydrogenated, more preferably 100% hydrogenated, and wherein the at least one block B is selected from a range of 15 wt. % to 45 wt. %, preferably of 20 wt. % to 40 wt. %, more preferably of 31 wt. %, in relation to the total weight of the thermoplastic elastomer, and wherein the thermoplastic elastomer has a glass transition temperature from a range of 120° C. to 230° C., preferably of 140° C. to 215° C., more preferably of 160° C. to 170° C., and wherein the polyolefin is a polypropylene homopolymer.

In a further preferred embodiment, the plastics composition comprises the thermoplastic elastomer in an amount selected from the range of 1 wt. % to 75 wt. %, preferably of 4 wt. % to 70 wt. %, more preferably of 10 wt. % to 60 wt. %, and comprises the polyolefin in an amount selected from the range of 25 wt. % to 99 wt. %, preferably of 35 wt. % to 96 wt. %, of 40 wt. % to 75 wt. %, in each case in relation to the total weight of the plastics composition, wherein the proportions of the composition are selected so as to make up 100 wt. % of the plastics composition in sum total, wherein the thermoplastic elastomer is a block copolymer, wherein the at least one block A is based on 1,3-butadiene, wherein the at least one block A is at least 80% hydrogenated, more preferably 100% hydrogenated, and wherein the at least one block B is selected from a range of 15 wt. % to 45 wt. %, preferably of 20 wt. % to 40 wt. %, more preferably of 31 wt. %, in relation to the total weight of the thermoplastic elastomer, and wherein the thermoplastic elastomer has a glass transition temperature from a range of 120° C. to 230° C., preferably of 140° C. to 215° C., more preferably of 160° C. to 170° C., and wherein the polyolefin is a polypropylene homopolymer.

The plastics composition is preferably provided by virtue of the respective components, for example at least the polyolefin and/or the thermoplastic elastomer, each being provided in a presentation form selected from the group consisting of powder, grit, pellets, granules, preferably cylindrical granules, cube-shaped granules, cylindrical granules, lenticular granules or splinter granules, and filaments, and being mixed. The mixing of the polyolefin and of the thermoplastic elastomer may be achieved by means of extruders, for example twin-screw extruders, kneaders, for example roll kneaders, static mixers, dynamic mixers, injection molding machines, or combinations thereof, wherein the plastics composition is obtained. In some non-limiting embodiments, the mixing is performed on an injection molding machine having a dynamic mixer or having a static mixer.

It is also possible for an optional manufacturing process, for example a deformation process, cutting process, coating process, to be carried out after the mixing. The presentation form of the plastics composition can thus be adapted to and optimized for the intended use.

In some non-limiting embodiments, the plastics composition is present in a presentation form selected from the group consisting of powder, grit, crumbs, pellets, granules and/or filaments. The granules may be present in the form of cylindrical granules, cube-shaped granules, cylindrical granules, lenticular granules and/or splinter granules.

By means of the above presentation forms of the plastics composition, this can be used in a large number of manufacturing processes, for example injection molding processes, extrusion processes, granulation processes, printing processes, for example filament printing processes, powder printing processes and/or granule printing processes, wherein, for example, the plastics composition is shaped to form the shaped article when the above processes are carried out.

A shaped article comprising the plastics composition may be used in a large number of technically demanding sectors. The shaped article is preferably used in power tools, automobiles, electrical engineering, aviation, aerospace, shipping, power plants, industrial plants in the chemical industry, medicine, electromobility and/or cooling systems.

It is possible that the plastics composition is present in the form of shaped articles. The shaped article is preferably an injection-molded shaped article, an extruded article or a printed shaped article.

It is also possible that the shaped article is present in the form of a line, pipe, connecting element, bodyshell part, dashboard, drilling machine housing, housings and/or shafts for the construction industry, rotor, bearing, housing, toothed gear or nozzle.

According to a non-limiting aspect 1, the present disclosure relates to a plastics composition that comprises at least one polyolefin and at least one thermoplastic elastomer, wherein the at least one thermoplastic elastomer is a copolymer that has at least one block A based on diene and at least one block B based on alpha-methylstyrene, wherein the ratio of the difference between the shrinkage of the polyolefin and the shrinkage of the plastics composition to the shrinkage of the polyolefin has at least a value of 30%, wherein the shrinkages are determined in accordance with DIN ISO 294-4.

According to a non-limiting aspect 2, the present disclosure relates to a plastics composition according to aspect 1, which is characterized in that the plastics composition comprises reinforcement fibers of up to 60 wt. % in relation to the total weight of the plastics composition.

According to a non-limiting aspect 3, the present disclosure relates to a plastics composition according to aspect 2, which is characterized in that the reinforcement fibers are or comprise glass fibers.

According to a non-limiting aspect 4, the present disclosure relates to a plastics composition according to aspect 3, which is characterized in that in that the glass fibers are flat fibers that preferably have a form factor of thickness to width from a range of 1:1.5 to 1:5.

According to a non-limiting aspect 5, the present disclosure relates to a plastics composition according to any one of the preceding aspects, which is characterized in that the polyolefin is selected from the group consisting of polypropylene (PP), for example polypropylene homopolymer (PPH), polypropylene copolymer (PPC), or polypropylene random copolymer (PPR), polyethylene (PE), for example high density polyethylene (HDPE), low density polyethylene (LDPE), linear low density polyethylene (LLDPE), very low density polyethylene (VLDPE), or medium density polyethylene (MDPE), ethylene vinyl acetate copolymer (EVA), ethylene ethyl acrylate copolymer (EEA), ethylene butyl acrylate copolymer (EBA) and the copolymers and mixtures thereof.

According to a non-limiting aspect 6, the present disclosure relates to a plastics composition according to any one of the preceding aspects, which is characterized in that the thermoplastic elastomer has a glass transition temperature from a range of 120° C. to 230° C.

According to a non-limiting aspect 7, the present disclosure relates to a plastics composition according to any one of the preceding aspects, which is characterized in that the block A based on diene is at least partially hydrogenated.

According to a non-limiting aspect 8, the present disclosure relates to a plastics composition according to any one of the preceding aspects, which is characterized in that the block A is selected from the group consisting of butadiene, isoprene and combinations thereof.

According to a non-limiting aspect 9, the present disclosure relates to a plastics composition according to any one of the preceding aspects, which is characterized in that the proportion of the block B in the thermoplastic elastomer lies in a range of 15 wt. % to 45 wt. % in relation to the total weight of the thermoplastic polymer.

According to a non-limiting aspect 10, the present disclosure relates to a plastics composition according to any one of the preceding aspects, which is characterized in that the plastics composition comprises the thermoplastic elastomer in an amount of up to 75 wt. % in relation to the total weight of the plastics composition.

According to a non-limiting aspect 11, the present disclosure relates to a plastics composition according to any one of the preceding aspects, which is characterized in that the plastics composition is present in a presentation form selected from the group consisting of powder, grit, crumbs, granules and/or filaments.

According to a non-limiting aspect 12, the present disclosure relates to a plastics composition according to any one of the preceding aspects, which is characterized in that the plastics composition is present in the form of shaped articles.

According to a non-limiting aspect 13, the present disclosure relates to a plastics composition according to any one of the preceding aspects, which is characterized in that the shaped article is an injection-molded shaped article, an extruded article or a printed shaped article.

According to a non-limiting aspect 14, the present disclosure relates to the use of the plastics composition according to any one of aspects 1 to 11 for injection molding, extrusion or additive manufacturing.

According to a non-limiting aspect 15, the present disclosure relates to a method for producing a shaped article, wherein the method comprises at least the following steps:
providing a plastics composition according to any one of aspects 1 to 10,
forming the provided plastics composition into a shaped article.

The disclosure will be discussed by way of example below on the basis of a plurality of exemplary embodiments and with reference to the appended drawing. The exemplary embodiments shown are merely examples and are therefore not to be understood as limiting.

### BRIEF DESCRIPTION OF THE DRAWING

FIG. 1 shows a thermogram for the determination of the glass transition temperature.

FIG. 1 shows a thermogram for the determination of the glass transition temperature, the datasets of which were created by means of dynamic mechanical analysis at a frequency of 11 Hz in the tension mode. For example, the determination of the glass transition temperature was performed by means of dynamic mechanical analysis in accordance with the method described in ISO 6721-11:2019-06. Plotted on the left-hand Y axis is the common logarithm of the modulus of elasticity (log(E′) in 10⁻⁵N/cm²) as a function of the temperature T in ° C. Plotted on the right-hand Y axis is the dimensionless loss angle (tan δ) as a function of the temperature T in ° C., which describes the damping properties. The black arrows on the measurement curves point toward the associated axes.

### DESCRIPTION

The unfilled circles and triangles show the profile for a conventional styrene-ethylene-butylene-styrene (SEBS). This thermoplastic elastomer is a copolymer and has a block based on styrene and a block based on ethylene and butylene.

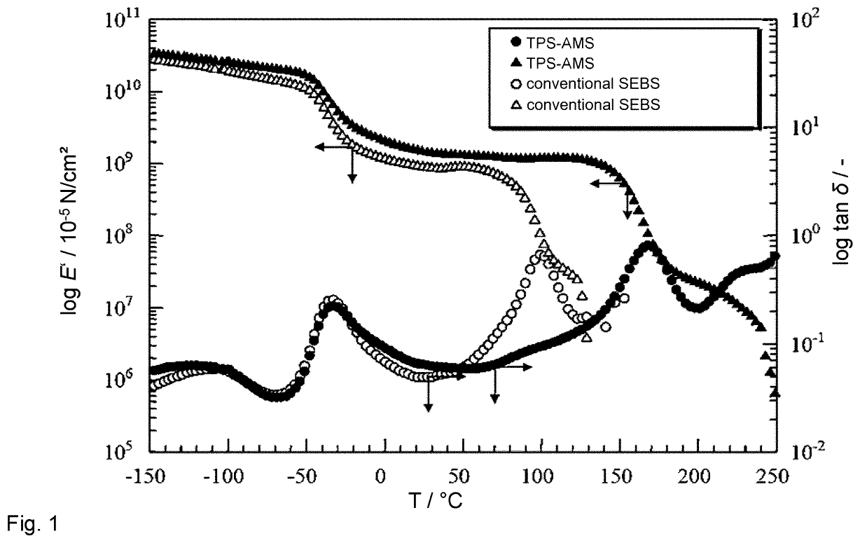

The filled circles and triangles show the profile for a thermoplastic elastomer, wherein the thermoplastic elastomer was a copolymer and had at least one block A based on diene and one block B based on alpha-methylstyrene (AMS). In the thermoplastic elastomer shown in FIG. 1, 100% hydrogenated 1,3-butadiene was selected for the diene of block A, and the proportion of the at least one block B was 31 wt. % in relation to the total weight. This polymer was therefore a thermoplastic elastomer from the subgroup of thermoplastic styrene block copolymers (TPS) based on alpha-methylstyrene, and will be referred to below and in the legend of FIG. 1 as TPS-AMS. The thermoplastic elastomer shown in FIG. 1 had a value for a melt flow index at 230° C. and under a load of 2.16 kg selected from a range of 5.6 g/10 min, for example in accordance with the method described in DIN EN ISO 1133-1:2012-03.

From the profile of the thermogram, it was possible for both types of thermoplastic elastomers to identify in each case two relatively significant changes in the logarithmically plotted modulus of elasticity as a function of the temperature (see the triangular symbols). Furthermore, in each case two temperature-dependent changes in the damping properties (tan δ) were evident (see the circular symbols).

From the respective maxima of tan δ, it was possible to determine the glass transition temperatures of the respective blocks of the polymers. Both thermoplastic elastomers had a maximum at approximately −30° C., which maximum is attributable to the block based on polyolefins. Both thermoplastic elastomers also had a further maximum at relatively high temperatures, which further maximum was attributable to the glass transition temperature of the block based on styrene in the case of the conventional SEBS or based on alpha-methylstyrene in the case of the thermoplastic elastomer of the plastics composition according to the present disclosure.

From the curve profile in FIG. 1, it was possible to identify that the block based on styrene in the conventional SEBS thus had a glass transition temperature of approximately 100° C. According to FIG. 1, the block based on alpha-methylstyrene in the thermoplastic elastomer of the plastics composition according to the present disclosure had a glass transition temperature of 160° C. to 170° C.

Table 1 shows main material parameters of polyolefins which are present in the form of and can be used as conventional plastics compositions. Furthermore, table 2 shows main material parameters of a glass-fiber-reinforced plastics composition of a polyolefin which has 30 wt. % reinforcement fibers, in the form of glass fibers having a spherical cross section, in relation to the total weight of the plastics composition. The polyolefins shown in table 1 and table 2 are intended to serve as comparative examples in relation to plastics compositions according to the disclosure. The abbreviation n. a. denotes values that are not available.

TABLE 1
Conventional plastics compositions based on polypropylene
homopolymer (PPH) as polyolefin (PO) and their properties
as a reference material and/or starting material for the
plastics composition according to the present disclosure.

| | PO1 | PO2 | PO3 | PO4 | PO5 |
|---|---|---|---|---|---|
| Type of PO | PPH | PPH | PPH | PPH | PPH |
| Melt flow index/ | 3.1 | 6.0 | 23 | 48 | 12 |
| g/10 min | | | | | |
| Shrinkage/% | 1.2/1.5 | 1/1.1 | 0.9/1 | 1/1 | 1/1.11 |
| Notched impact strength | 4 | 3.5 | 3 | 3 | 3.3 |
| (Charpy)/kJ/m² | | | | | |
| Impact strength | 145 | 140 | 91 | 87 | 115 |
| (Charpy)/kJ/m² | | | | | |
| Heat deflection | 115 | 55 | 105 | 105 | 110 |
| temperature (HDT-B)/ | | | | | |
| ° C. | | | | | |

TABLE 2
Conventional plastics composition comprising reinforcement
fibers (round fibers) based on polypropylene homopolymer
(PPH) as polyolefin (PO) and their properties as a reference
material and/or starting material for the plastics composition
according to the present disclosure.

| | POG1 |
|---|---|
| Type of PO | PPH |
| Proportion of reinforcement fibers/ | 30 |
| wt. % | |
| Shrinkage/% | 0.2/0.8 |
| Distortion/mm | 16.45 |
| Notched impact strength (Izod)/ | 10.4 |
| kJ/m² | |
| Notched impact strength (Charpy)/ | 10 |
| kJ/m² | |
| Impact strength (Charpy)/kJ/m² | 48.4 |
| Heat deflection temperature (HDT-B)/ | 159 |
| ° C. | |

Table 3 and table 4 show main material parameters of plastics compositions A1 to A4 and B1 to B7, which had at least one polyolefin and at least one thermoplastic elastomer as described herein. In the plastics compositions A1 to A4 and B1 to B5, the polyolefin was a polypropylene homopolymer (PPH). In the plastics compositions B6 and B7, the polyolefin was a mixture of polypropylene homopolymer (PPH) in a proportion of 85 wt. % and linear low density polyethylene (LLDPE) in a proportion of 15 wt. %. The thermoplastic elastomer was a thermoplastic styrene block copolymer and contained at least one block A based on diene and at least one block B based on alpha-methylstyrene. In this specific case, the plastics composition comprised the TPS-AMS that was analyzed in the thermogram in FIG. 1. The plastics compositions A1 to A4 according to table 3 had the thermoplastic elastomer in a proportion of between 25 wt. % and 60 wt. % in relation to the total weight of the plastics composition.

The plastics compositions B1 to B7 according to table 4 had the thermoplastic elastomer in a proportion of between 5 wt. % and 25 wt. % in relation to the total weight of the plastics composition. Additionally, the plastics compositions B1 to B7 had reinforcement fibers in the form of flat glass fibers, wherein the proportion of the reinforcement fibers in relation to the total weight of the plastics composition varied between 15 wt. % and 20 wt. %.

The melt flow indices of the plastics compositions described in tables 1 to 4 were determined at 230° C. and under a load of 2.16 kg, for example in accordance with the method described in DIN EN ISO 1133-1:2012-03.

Plastics compositions having a melt flow index of greater than 3 g/10 min were, owing to their relatively low viscosity, particularly well suited to extrusion processes and/or injection molding processes. Plastics compositions that are used in injection molding processes and extrusion processes are subjected to stresses that lead to increased orientation of the polymer chains. The orientation of the polymer chains in turn means that increased shrinkage can be expected. Such plastics compositions thus typically exhibited shrinkage of up to 2% both in the longitudinal direction and in the transverse direction, which was reflected in reduced dimensional stability of the shaped articles. Plastics compositions having a melt flow index of greater than 3 g/10 min were additionally very well suited to printing processes such as filament printing processes.

The shrinkages in the longitudinal direction and the shrinkages in the transverse direction were determined by means of the method described in DIN ISO 294-4, wherein the starting dimensions of an injection-molded plate were as follows: width: 61 mm, length: 61 mm, height: 2 mm.

The distortion of the particular plastics composition was determined on a plate having the starting dimensions of width: 150 mm, length: 100 mm, height: 2 mm, as already discussed above.

The Charpy notched impact strengths and impact strengths of the plastics compositions according to tables 1 to 4 were determined at 23° C. by means of the respective methods described in DIN EN ISO 179-1:2010-11.

The Izod notched impact strengths were determined at 23° C. by means of the method described in DIN EN ISO 180:2020-03.

In the determination of the impact strength and the notched impact strength, the abbreviation “NB” was used for test specimens which, even after the impact test, did not break into two parts, were bent, and/or elastically sprung back after the impact despite the notch. In some non-limiting embodiment, test specimens that did not break at a load of less than 80 kJ/m² during the determination of the notched impact strengths and impact strengths were evaluated as “NB”.

The heat deflection temperature (HDT) according to method B was determined in accordance with DIN EN ISO 75-1:2020-06 and DIN EN ISO 75-2:2013-08 and was abbreviated to HDT-B. In method B, a force per unit area of 0.45 N/mm² was applied to the test specimen by means of weights and/or springs.

The plastics compositions A1 to A4 and B1 to B7 were provided by virtue of the respective components, for example at least the polyolefin and/or the thermoplastic elastomer, each being provided in the form of granules, powder, flakes or crumbs and being mixed.

The mixing of the polyolefin and the thermoplastic elastomer was performed by means of twin-screw extruders and roll kneaders, wherein the plastics compositions A1 to A4 and B1 to B7 were obtained.

The obtained plastics compositions A1 to A4 and B1 to B7 were present in the form of granules.

Molded articles in the form of test specimens were subsequently molded from the plastics composition in order to determine the parameters stated in tables 3 and 4.

TABLE 3
Plastics compositions which contained at least
polypropylene homopolymer (PPH) as polyolefin
(PO) and TPS-AMS (n.a.: not available).

| | A1 | A2 | A3 | A4 |
|---|---|---|---|---|
| Type of PO | PPH | PPH | PPH | PPH |
| Proportion of TPS-AMS/ | 60 | 40 | 30 | 25 |
| wt. % | | | | |
| Melt flow index/ | 12 | 12 | 3.1 | 3.1 |
| g/10 min | | | | |
| Shrinkage/% | 0.4/0.5 | 0.7/0.7 | 0.5/0.6 | 0.6/0.9 |
| Notched impact strength | 55 | 60 | 63 | 60 |
| (Izod)/kJ/m² | | | | |
| Notched impact strength | n.a. | 81 | NB | 70 |
| (Charpy)/kJ/m² | | | | |
| Impact strength | NB | NB | NB | NB |
| (Charpy)/kJ/m² | | | | |
| Heat deflection | 61 | 66 | 73 | n.a. |
| temperature (HDT-B)/ | | | | |
| ° C. | | | | |
| Use | Injection | Injection | Filament | Filament |
| | molding | molding | printing, | printing, |
| | | | Granule | Granule |
| | | | printing, | printing, |
| | | | Extrusion | Extrusion |

TABLE 4
Plastics compositions according to the present disclosure which contain polypropylene homopolymer
(PPH) and/or linear low density polyethylene as polyolefin (PO) and TPS-AMS, wherein the plastics
compositions additionally contained reinforcement fibers (flat fibers) (n.a.: not available).

| | B1 | B2 | B3 | B4 | B5 | B6 | B7 | B8 |
|---|---|---|---|---|---|---|---|---|
| Type of PO | PPH | PPH | PPH | PPH | PPH | PPH/ | PPH/ | PPH/ |
| | | | | | | LLDPE | LLDPE | LLDPE |
| Proportion of | 5 | 10 | 15 | 15 | 20 | 15 | 20 | 11 |
| TPS-AMS/wt. % | | | | | | | | |
| Proportion of | 50 | 50 | 50 | 30 | 50 | 25 | 15 | 10 |
| reinforcement | | | | | | | | |
| fibers/wt. % | | | | | | | | |
| Shrinkage/% | 0.1/0.4 | 0.1/0.3 | 0/0.05 | 0/0.3 | 0.1/0.3 | 0.2/0.4 | 0.2/0.4 | 0.1/0.4 |
| Distortion/mm | 0.25 | 0.18 | 0.03 | n.a. | n.a. | 3.08 | 3.5 | n.a. |
| Notched impact | 18 | 23 | 26 | 26 | 28 | 36 | 34 | 14 |
| strength | | | | | | | | |
| (Izod)/kJ/m² | | | | | | | | |
| Notched impact | 19 | 22 | 25 | 26 | 28 | 39 | 33 | 14 |
| strength | | | | | | | | |
| (Charpy)/kJ/m² | | | | | | | | |
| Impact strength | 73 | 80 | 75 | 73 | 70 | 88 | 76 | 42 |
| (Charpy)/kJ/m² | | | | | | | | |
| Heat deflection | 162 | 161 | 158 | 158 | 158 | 141 | 134 | 145 |
| temperature | | | | | | | | |
| (HDT-B)/° C. | | | | | | | | |
| Use | Injection | Injection | Injection | Injection | Injection | Extrusion | Extrusion | Extrusion |
| | molding | molding | molding | molding | molding | | | |

From the parameters set out in tables 3 and 4, it is evident that the plastics compositions according to the present disclosure exhibited very low shrinkages. The measured shrinkages of the plastics compositions A1 to A4 were only 0.4% to 0.7% in the longitudinal direction and 0.5% to 0.9% in the transverse direction.

The measured shrinkages were thus lower than the typical shrinkages to be expected for partially crystalline thermoplastic materials, as mentioned further above. They were in fact in the range considered typical for the shrinkage of amorphous thermoplastic materials.

By adding the reinforcement fibers, it was possible to yet further reduce the shrinkage of the plastics composition. This is apparent from the shrinkages that were determined for the plastics compositions B1 to B7. The plastics compositions B6 and B7, which contained mixtures of PPH and LLDPE as polyolefin, had the highest values out of the plastics compositions in table 4, with 0.2% in the longitudinal direction and 0.4% in the transverse direction, wherein the proportion of thermoplastic elastomer was 15 wt. % or 20 wt. %, and the proportion of flat glass fibers was 25 wt. % or 15 wt. % respectively, in each case in relation to the total weight of the plastics composition. It should however be noted that the plastics compositions B6 and B7 had the highest values for the notched impact strength within the group of plastics compositions B1 to B7. Particularly noteworthy are the plastics compositions B3 and B4, for which no shrinkage was measurable in the longitudinal direction. These plastics compositions each had a proportion of 15 wt. % thermoplastic elastomer and 50 wt. % or 30 wt. % flat glass fibers, in each case in relation to the total weight of the plastics composition. In the transverse direction, the shrinkage was only 0.05% or 0.3% respectively.

Below, the plastics compositions according to the present disclosure from tables 3 and 4 will be compared with the conventional plastics compositions.

Here, the plastics compositions A1 and A2 from table 3 were based on the polyolefin of the plastics composition PO5 from table 1, wherein the plastics compositions A1 and A2 additionally had the thermoplastic elastomer according to FIG. 1. The plastics compositions A3 and A4 from table 3 were based on the polyolefin of the plastics composition PO1 from table 1, wherein the plastics compositions A3 and A4 additionally had the thermoplastic elastomer according to FIG. 1.

The plastics compositions A1, A2, A3 and A4 all exhibited reduced shrinkages in the longitudinal direction and in the transverse direction in relation to the plastics compositions PO1 and PO5, which consisted only of a polyolefin. According to equations (2) and (3), it was possible for the shrinkage in the longitudinal direction to be reduced by at least 30% to 60%, whilst it was possible for the shrinkage in the transverse direction to be reduced by 36% to 55%.

In other words, the plastics compositions according to the present disclosure comprising a polyolefin and the thermoplastic elastomer, wherein the thermoplastic elastomer was a thermoplastic styrene block copolymer that had at least one block A based on diene and at least one block B based on alpha-methylstyrene, exhibited reduced shrinkage in relation to plastics compositions that contained only the polyolefin.

TABLE 5
Comparison of a conventional plastics composition with plastics
compositions according to the present disclosure with regard to
shrinkage in the longitudinal direction and in the transverse
direction, calculated in accordance with equations (2) and (3).

| | A1/PO5 | A2/PO5 | A3/PO1 | A4/PO1 |
|---|---|---|---|---|
| Ratio of shrinkage | 60% | 30% | 58% | 50% |
| (longitudinal direction) | | | | |
| Ratio of shrinkage | 55% | 36% | 50% | 47% |
| (transverse direction) | | | | |

Table 6 shows, for comparison, the shrinkages of plastics compositions having glass reinforcement fibers. The plastics compositions B3, B4 and B5 according to the present disclosure from table 4 and the plastics composition PPG1 from table 2 were used for this purpose, wherein the plastics compositions B3, B4 and B5 additionally have the thermoplastic elastomer according to FIG. 1.

The plastics compositions B3, B4 and B5 all exhibit reduced shrinkages in the longitudinal direction and in the transverse direction in relation to the plastics composition PPG1, which consists only of a glass-fiber-reinforced polyolefin.

TABLE 6
Comparison of the reduction of the shrinkage in the longitudinal
direction and in the transverse direction of a conventional glass-
fiber-reinforced plastics composition with plastics compositions
according to the present disclosure which have reinforcement fibers.
Values calculated in accordance with equations (2) and (3).

| | B3/PPG1 | B4/PPG1 | B5/PPG1 |
|---|---|---|---|
| Ratio of shrinkage | 100% | 100% | 50% |
| (longitudinal direction) | | | |
| Ratio | 94% | 63% | 63% |
| (transverse direction) | | | |

From the comparison of the distortion of the plastics composition B3 and PPG1, it is additionally apparent that, aside from the shrinkage, the distortion of the plastics composition B3 (0.03 mm) was also less than the distortion of the plastics composition PPG1 (16.45 mm) by more than an order of magnitude, or virtually no distortion occurred. This was surprising, because it was expected that the plastics composition PPG1 would exhibit less distortion, owing to the reinforcement fibers contained therein, than a non-reinforced plastics composition.

Furthermore, the heat deflection temperature HDT-B of the plastics compositions B3, B4 and B5, with a value of 158° C., differs only by 1° C. from the heat deflection temperature HDT-B of PPG1. This high value, or the small difference, was surprising, because the plastics compositions had the thermoplastic elastomer in proportions of 15 wt. % or 20 wt. % in relation to the total weight of the plastics composition, and the addition of a conventional elastomer would be expected to result in a reduction of the heat deflection temperature. Rather, it was found that the heat deflection temperature HDT-B was virtually independent of the addition of the thermoplastic elastomer.

It is also clear from the parameters set out in tables 3 and 4 that component parts consisting of the compositions according to the present disclosure exhibited very good properties. They exhibited very high impact strength and notched impact strength, for example in relation to conventional plastics compositions.

In summary, as presented above, it was made possible by means of the plastics compositions according to the present disclosure to provide shaped articles which exhibited high dimensional stability owing to very low shrinkage, both in the longitudinal direction and in the transverse direction, and exhibited low distortion, for example in relation to conventional plastics compositions. This was attributable to the high glass transition temperature of the thermoplastic elastomer as described herein, as a result of which crystallization and solidification commenced very rapidly after the injection of the molten plastics composition. Furthermore, the shaped articles obtained from the plastics composition exhibited not only the low shrinkage but also improved mechanical properties such as high impact strength and high notched impact strength, which was attributable to the addition of the thermoplastic elastomer. It was thus possible to obtain a plastics composition which exhibited the advantageous properties of partially crystalline thermoplastic materials and also the easy processability and low shrinkage typical of amorphous thermoplastic materials.

The design variants presented may self-evidently be combined with one another as desired, and do not constitute any limitation.

1. A plastics composition comprising at least one polyolefin and at least one thermoplastic elastomer,
wherein the at least one thermoplastic elastomer is a copolymer that has at least one block A based on diene and at least one block B based on alpha-methylstyrene,
wherein the ratio of the difference between a shrinkage of the polyolefin and a shrinkage of the plastics composition to the shrinkage of the polyolefin has at least a value of 30%, wherein the shrinkages are determined in accordance with DIN ISO 294-4,
wherein the plastics composition comprises inorganic reinforcement fibers in an amount of 10 wt. % to 70 wt. % in relation to the total weight of the plastics composition, wherein the inorganic reinforcement fibers are formed as flat fibers.

2. The plastics composition according to claim 1,
wherein the inorganic reinforcement fibers further comprise round fibers in a proportion of up to 60 wt. % in relation to the total weight of the plastics composition, wherein the total amount of inorganic reinforcement fibers formed as flat fibers and inorganic reinforcement fibers formed as round fibers does not exceed 70 wt. % in relation to the total weight of the plastics composition.

3. The plastics composition according to claim 1,
wherein the flat fibers have a form factor of thickness of the fiber cross section to width of the fiber from a range of 1:1.5 to 1:5.

4. The plastics composition according to claim 1,
wherein the inorganic reinforcement fibers are selected from the group consisting of carbon fibers, ceramic fibers, basalt fibers, glass fibers, metallic fibers, and mixtures thereof.

5. The plastics composition according to claim 4,
wherein the inorganic reinforcement fibers are or comprise glass fibers.

6. The plastics composition according to claim 1,
wherein the polyolefin is selected from the group consisting of polypropylene (PP), polypropylene homopolymer (PPH), polypropylene copolymer (PPC), of polypropylene random copolymer (PPR), polyethylene (PE), high density polyethylene (HDPE), low density polyethylene (LDPE), linear low density polyethylene (LLDPE), very low density polyethylene (VLDPE), medium density polyethylene (MDPE), ethylene vinyl acetate copolymer (EVA), ethylene ethyl acrylate copolymer (EEA), ethylene butyl acrylate copolymer (EBA), copolymers thereof, and mixtures thereof.

7. The plastics composition according to claim 1,
wherein the thermoplastic elastomer has a glass transition temperature from a range of 120° C. to 230° C.

8. The plastics composition according to claim 1,
wherein the block A based on diene is at least partially hydrogenated.

9. The plastics composition according to claim 1,
wherein the block A is selected from the group consisting of butadiene, isoprene, and combinations thereof.

10. The plastics composition according to claim 1,
wherein the proportion of the block B in the thermoplastic elastomer ranges from 15 wt. % to 45 wt. % in relation to the total weight of the thermoplastic polymer.

11. The plastics composition according to claim 1,
wherein the plastics composition comprises the thermoplastic elastomer in an amount of up to 75 wt. % in relation to the total weight of the plastics composition.

12. The plastics composition according to claim 1,
wherein the plastics composition further comprises at least one mineral particulate solid selected from the group consisting of talc, metal carbonate, and mixtures thereof.

13. The plastics composition according to claim 12,
wherein the metal carbonate comprises or consists of chalk.

14. The plastics composition according to claim 12,
wherein the plastics composition comprises the at least one mineral particulate solid in a proportion of at most 45 wt. % in relation to the total weight of the plastics composition.

15. The plastics composition according to claim 1,
wherein the plastics composition is present in a form selected from the group consisting of powder, grit, crumbs, granules, filaments, and mixtures thereof.

16. The plastics composition according to claim 1,
wherein the plastics composition is present in the form of shaped articles.

17. The plastics composition according to claim 16,
wherein the shaped article is an injection-molded shaped article, an extruded article or a printed shaped article.

18. (canceled)

19. A method for producing a shaped article, wherein the method comprises:
providing a plastics composition according to claim 1,
forming the provided plastics composition into a shaped article.
